(19) United States
(12) Patent Application Publication
(10) Pub. No.: US 2016/0066652 A1
(43) Pub. Date: Mar. 10, 2016

(54) MEANS TO ELIMINATE BOW TIE KNOTTING OF A SHOE LACE

(71) Applicants: Gary O. Sandstedt, St. Louis, MO (US); Roby Edwards, St. Louis, MO (US)

(72) Inventors: Gary O. Sandstedt, St. Louis, MO (US); Roby Edwards, St. Louis, MO (US)

(21) Appl. No.: 14/477,015

(22) Filed: Sep. 4, 2014

(51) Int. Cl. A43C 7/00; H05B 33/08; H05B 37/02; A43C 11/24; H01H 13/14

(52) U.S. Cl. CPC A43C 7/00; A43C 11/24; H01H 13/14; H05B 37/0209; H05B 33/0815

(57) ABSTRACT

This invention obviates the need to bow tie a foot apparel lacing string, by substituting a push-button clamping mechanism housed in a foot apparel hosted tubing structure.

The tubular structure functions in combination with an array of substrate mounted light emitting diodes, powered by a battery to form a single entity.

The subject of this invention is a portable device, which can be transferred among various types of foot apparel.

### BACKGROUND OF THIS INVENTION

Most shoes, and other foot apparel come with lacing strings that invariably become untied, at the most inconvenient times.

There is a need to secure a lacing string by means other than the traditional bow tie knot.

Since conventionally tied lacing strings can become untied, they present a danger if an untied lacing string is stepped on by the opposite foot, impeding it to move forward, which can then result in the wearer falling down, and being injured.

This invention removes that possibility, since the foot apparel is no longer held in place with the traditional bow tie knot to subsequently become untied.

This invention secures apparel on a foot, by means of a push button mechanism, which holds the lacing string in a fixed position, through the use of a clamping device.

This invention also provides a surface on the push button mechansim for hosting an array of decorative light emitting diodes.

### OBJECTS OF THIS INVENTION

1. To provide a fast, convenient, and simple way to secure wearing apparel on a foot.

2. To eliminate the possibility of a foot apparel lacing string becoming untied.

3. To provide a means that eliminates the hazard of an untied foot apparel lacing string becoming the facilitater of an accidental fall.

4. To provide a simple means for small children, the infirmed, and others to quickly secure wearing apparel on the foot.

5. To provide a means to secure an LED device onto foot apparel, held in place by the lacing strings.

6. To replace bow tying of a foot apparel lacing string, with a lacing string securing mechanism that hosts a decorative display of light emitting diodes.

### PRIOR ART CITED

There are many ways to secure foot apparel, with lacing strings secured by a bow tie knot being the most common.

Velcro straps, mechanical clamping devices, zippers, buckles, hooks, and elastic bands integral to foot apparel, also provide alternatives to bow tie knotting of foot apparel lacing strings.

Liu U.S. Pat. No. 6,510,627 B1, dated 28 Jan. 2003; Curet U.S. Pat. No. 6,725,575 B2, dated 27 Apr. 2004; and Cheng U.S. Pat. No. 7,574,786 B2, dated 18 Aug. 2009, all cite different mechanical configurations of securing a shoe lacing string in place, in lieu of bow tie knotting, with the common denominator of each being a basic clamping means.

Liu U.S. Pat. No. 6,510,627 B1, describes a mechanical pressure clamp device securing a shoe lacing string in lieu of bow tie knotting.

There is no disclosure in Liu U.S. Pat. No. 6,510,827 B1, describing a shoe lacing string tying mechanism, being combined, or remotely associated with an LED configuration, all as a single entity, hosted by foot worn apparel.

Curet patent, U.S. Pat. No. 6,725,575 B2 describes a mechanical pressure clamp device securing a shoe lacing string in lieu of bow tie knotting.

There is no disclosure in Curet U.S. Pat. No. 6,725,575 B2, describing a shoe lacing string tying mechanism, being combined, or remotely associated with an LED configuration, all as a single entity, hosted by foot worn apparel.

Cheng U.S. Pat. No. 7,574,786 B2, describes a mechanical pressure clamp device securing a shoe lacing string, in lieu of bow tie knotting.

There is no disclosure in Chen U.S. Pat. No. 7,574,786 B2, describing a shoe lacing string tying mechanism, being combined, or remotely associated with an LED configuration, all as a single entity, hosted by foot worn apparel.

Attachable forms of wearing apparel lighting are common in in the marketplace.

Schrimmer U.S. Pat. No. 8,376,565, describes one such example of lighted gloves.

Forbes U.S. Pat. No. 7,866,066 B1, describes another such example of an LED configuration affixed to a shoe.

There is no disclosure in Forbes U.S. Pat. No. 7,866,066 B1, describing an LED configuration, being combined as a single entity, or associated with a shoe tying mechanism, hosted by foot worn apparel.

### IN SUMMATION

Prior art does not reveal the widely diverse, unassociated technologies of shoe tying and LED's, combined, to jointly function as a single entity on a shoe, or other foot worn apparel.

### FEATURES OF THIS INVENTION INCLUDE

A. A quick, push-button means of securing wearing apparel on a foot.

B. The elimination of the bow tie knot, traditionally used to secure wearing apparel on a foot.

C. A means to combine an LED configuration in combination with foot wearing apparel lace tying.

### BRIEF DESCRIPTION OF THE DRAWINGS

FIG. 1, shows a profile of this inventions internal tubular structure.

FIG. 2, shows a side view of the tubular structure, hosting a substrate with mounted light emitting diodes.

FIG. 3, shows a top view of the tubular structure hosting a substrate with mounted light emitting diodes.

FIG. 4, shows a diagram of the circuitry powering the light emitting diodes.

FIG. 5, shows a top view of a shoe with the tubular structure hosting a substrate with light emitting diodes.

FIG. 6, shows a top view of a shoe hosting the tubular structure, secured by a lacing string.

### DESCRIPTION OF AN EMBODIMENT

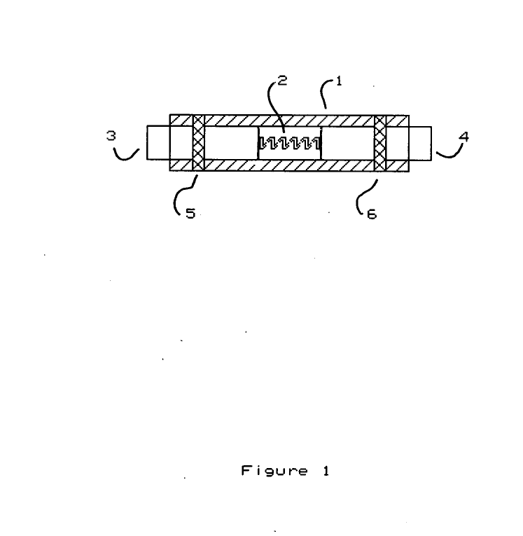

FIG. 1, shows tubular structure 1, housing centrally located compression-expansion spring 2, flanked by push button rods 3, and 4.

Traversing tubular structure 1, and push button rods 3, and 4, are respective aligned holes 5, and 6, through which each end of a lacing string is threaded.

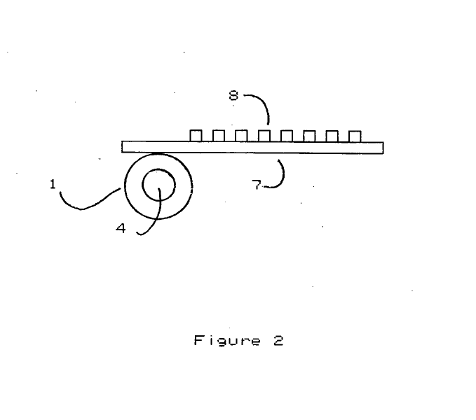

FIG. 2, shows a profile view of tubular structure 1, with push button 4, both of FIG. 1, with added attached device, comprised of substrate 7, hosting a profiled series of light emitting diodes 8.

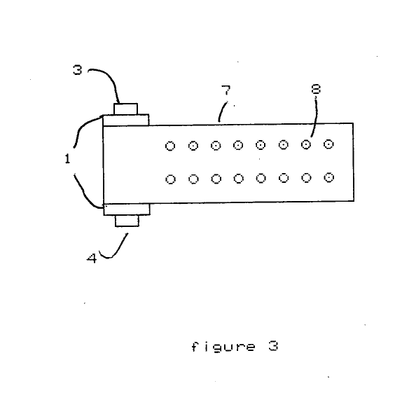

FIG. 3, shows a top view of FIG. 2, with tubular structure 1, and respective opposing push buttons 3, and 4, also of FIG. 1.

FIG. 3, further shows a top view of tubular structure 1, hosting substrate 7, of FIG. 2, with a full series of light emitting diodes 8, partially profiled in FIG. 2.

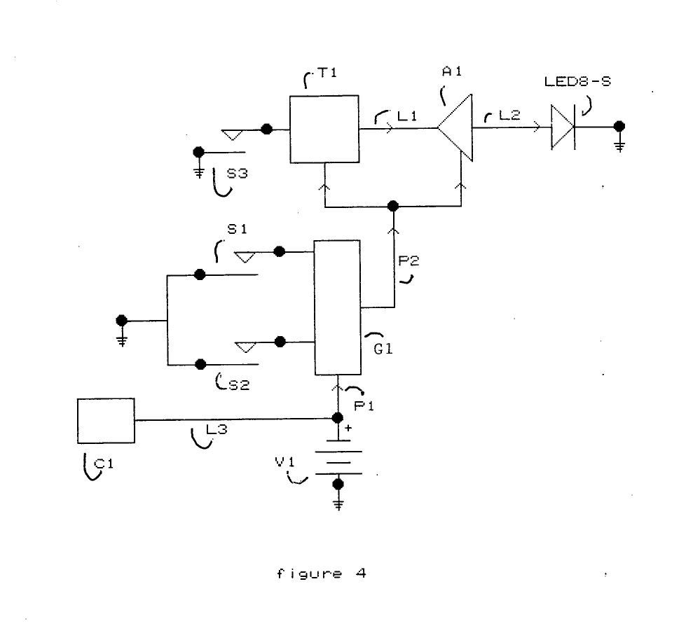

FIG. 4, shows a block diagram of the electronic circuitry used to power, light emitting diodes 8, of FIGS. 2, and 3.

As further depicted in FIG. 4, switch S1, when momentarily closed, energizes gate circuitry G1, voltage sourced by battery V1, through voltage line P1.

Gate circuitry G1, then energizes timer circuit T1, and power amplifier A1, through voltage line P2.

Activated Timer T1, then modulates the voltage output of amplifier A1, through control line L1.

The modulated voltage output from amplifier A1, through connecting power line L2, then flashes light emitting diodes LED8-S, on and off, in cadence with the signal outputted from timer T1.

Switch S2, of FIG. 4, when momentarily closed, turns off all operational voltage sourced from battery V1, through gate G1, to timer T1, amplifier A1, and light emitting diode LED8-S.

Switch S3, when momentarily closed shuts off timer T1, and allows light emitting diodes, LED8-S to remain on constantly without cycling on and off.

FIG. 4, also shows battery charger C1, connected to rechargeable battery V1, through power line L3.

The source of power for battery charger C1, can be any sustaining external voltage, of the proper polarity.

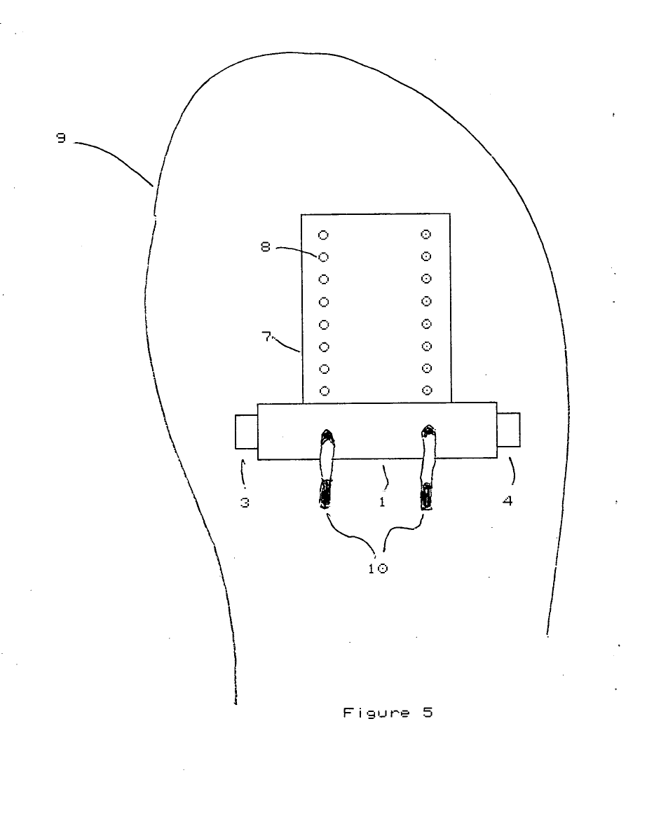

FIG. 5, depicts a top view of tubular structure 1, flanked by push buttons 3, and 4, with the attached configurations of FIGS. 2, and 3, comprised of substrate 7, hosting light emitting diodes 8, all of which are anchored to shoe 9, as a single entity, by interfacing shoe lacing string 10.

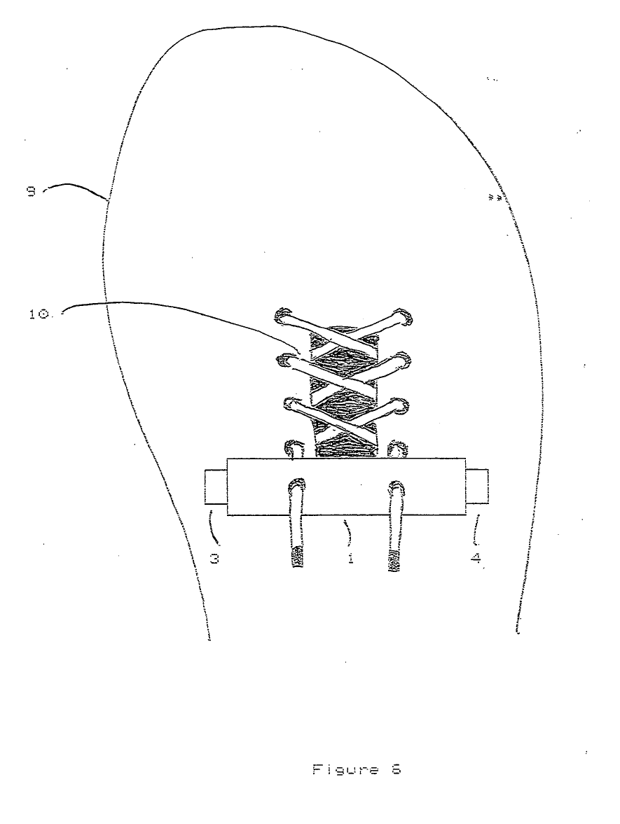

FIG. 6, depicts a top view of tubular structure 1, flanked by push buttons 3, and 4, all secured by interfacing shoe lacing string 10, to host shoe 9.

What is claimed:

1. A means to eliminate bow tie knotting of a shoe lace string, on a shoe, comprising a portable tubular structure, housing a centrally located compression-expansion spring, flanked at each end by a rod, whose opposite, outer ends extend a distance beyond each opposing end of the tubular structure, to form push buttons, which, when jointly pressed inward, move against the force exerted by the centrally located compression-expansion spring, and bring into alignment a hole in each of the two push-button rods, with a respective, corresponding hole, transversing the tubular structure, at right angles to its length, of a similar diameter, each located an equal distance, of a fixed dimension, from the center of the tubular structure, which, through each, an opposite end of a conventional shoe lace string is freely threaded, then drawn tight; and subsequently locked in place, when each push-button of the structure is jointly released, to hold the shoe lace string in a taut state, on a host shoe, by means of the holes of the tubular structure, and the respective holes of the internally housed push-button rods, assuming an offset position, producing a clamping effect, through pressure exerted by the re-expanding centrally located compression-expansion spring.

2. The invention of claim 1, comprising a tubular structure, held in place on a host shoe by its shoe lace string.

3. The invention of claim 1, comprising means to host at least one ancillary device.

4. The invention of claim 1, comprising a tubular structure with at least one surface to host an attachable ancillary device.

5. The invention of claim 1, comprising an electrified ancillary device.

6. The invention of claim 1, comprising means of an electrified ancillary device, powered by a battery.

7. The invention of claim 1, whose ancillary battery is rechargeable.

8. The invention of claim 1, comprising an attachable ancillary device hosting an array of light emitting diodes.

9. The invention of claim 1, comprising an ancillary device whose light emitting diodes, emit at least one color.

10. The invention of claim 1, whose light emitting diodes are optionally modulated in an on and off state.

11. The invention of claim 1, comprising an ancillary device whose hosted electronics are controlled by an on and off switching means.

12. The invention of claim one, comprising an ancillary device whose light emitting diodes form a pattern.

14. The invention of claim 1, comprising means of a portable ancillary device.

15. The invention of claim 1, comprising means of an ancillary device transferable from one shoe to another.

16. The invention of claim 1, comprising-means of a tubular structure of at least one color.

17. The invention of claim 1, comprising a tubular structure displaying nomenclature.

18. The invention of claim 1, comprising a tubular structure, configured three dimentionally.
